(19) United States
(12) Patent Application Publication
(10) Pub. No.: US 2012/0245956 A1
(43) Pub. Date: Sep. 27, 2012

(54) Pharmacy-based data transfer methodology

(76) Inventor: Amina A. Damji, Flemington, NJ (US)

(21) Appl. No.: 13/065,610

(22) Filed: Mar. 25, 2011

(51) Int. Cl. G06Q 50/00; G06Q 10/00

(52) U.S. Cl. 705/3

(57) ABSTRACT

A pharmacy-based data transfer methodology includes providing at least one computer with sufficient software and hardware to perform the following: (i) receive and store a set of unique identifiers corresponding to a specific patients; (ii) receive prescription medication information data on those patients, attaching received prescription medication information data to the corresponding unique identifier and storing it, and (iii) generate a printed pharmacy data card for a patient showing and corresponding prescription medication information data for each of the prescriptions that have been stored for the patient; and, providing the printed pharmacy data card to its corresponding patient.

### BACKGROUND OF INVENTION

a. Field of Invention

The invention relates generally to a methodology for transferring pharmacy-based data. Often patients on prescription medication(s) are hospitalized, for planned surgery, for exploratory surgery or testing or for emergency treatment. One of the time consuming steps in the process of admitting patients into a hospital, clinic or even a new doctor or a specialist doctor's office is the procurement of prescription drug-related (pharmacy-based) information. This pharmacy-based data includes personal identification information, as well as prescription treatment data, such as what the patient is currently taking, has recently taken and what allergies, adverse reactions or interactions may have occurred. Often, the patient does not remember everything or makes mistakes about prescription and related history when checking in for treatment or testing. Too often, the admitting hospital or new treating physician must call the pharmacy to procure this information to appropriately treat the patient.

The present invention is directed to automatically giving the patient a printout of pharmacy history to be carried on his/her person (wallet, purse or the like) to be used for immediate, accurate and thorough pharmacy-related information upon admission or checking in for treatment or testing. Each time the patient goes to a pharmacy or chain of pharmacies, to fill a new or refill and old prescription, the patient is automatically provided with an updates print out and has the card or sheet always available. The present invention is advantageous over information chips because it is less expensive, more user friendly and can be provided in areas where chips may be too costly or technologically unavailable.

b. Description of Related Art

The following patents are representative of the field pertaining to the present invention:

U.S. Pat. No. 7,606,723 B2 to Mayaud describes professional data management systems useful in the production of product specification documents such as prescriptions, service or parts orders, insurance contracts and the like that require detailed product and history information from multiple extensive information sources, especially remote heterogenous sources. More particularly, the invention relates to systems that assist professionals perform their everyday work in specifying customized technical products. A particularly preferred embodiment relates to a computer-implemented prescription management system to assist physicians in prescribing and reviewing drugs.

U.S. Pat. No. 7,343,302 B2 to Aratow et al. describes an information and resource management system for collecting data from diverse sources and organizing multiple types of data and information to facilitate dynamic multi-dimensional displays that will enhance cognition and situational awareness for diverse user communities. This system may facilitate collaborative cross-agency research and response to public health and safety issues. The system will generate more rapid awareness of potentially critical situations and promote greater awareness of the cost and benefits of alternative courses of action across diverse agencies and organizations serving common populations and communities. The invention includes customized geographically enabled data collection tools and techniques, dedicated databases and parsing schemes that feed into customized data visualization and simulation engines that drive the display of context sensitive interactive environments on a wide variety of computing platforms. The invention provides a novel approach to inter-disciplinary information integration processing, visualization, sharing and decision-making in the domain of public health and safety, disaster management and mitigation.

U.S. Pat. No. 6,988,075 B1 to Hacker describes an electronic medical record system and service for centrally storing patients, medical records electronically on a database for patient-controlled remote access by both patients and medical providers. The system stores a plurality of patient medical records on a medical information database via a medical information server connected to a network. A plurality of medical provider computers connected to the network has software to communicate with the medical information server. Patients supply authorization means to allow medical provider computers to access patient-selected portions of the patient's medical record for viewing and updating of the patient's medical record. Additionally, patients can access all portions of their medical record using browser software on any browser-enabled device connected to the network.

U.S. Pat. No. 6,830,180 B2 to Walsh describes a method for verification of the identity of a patient to which a medical treatment is to be delivered. The identity of the patient is verified and the treatment to be delivered is checked. In some embodiments, an identifying element such as patient chart or patient photograph is provided for the patient which includes a patient identifier, e.g., a barcode, capable of being read by a reader device located within the treatment room. In these embodiments, the patient identifier is read by the reader device in the treatment room and a characteristic audio signal, previously assigned to the patient and known to the patient, is generated in response to the reading of the identifying element when there is a match between the patient identifier and a stored identifier for the patient. Treatment of the patient is at least temporarily withheld if any audio signal generated in response to reading of the patient identifier by the reader device is not the characteristic audio signal assigned to the patient. A special patient chart with a removable identifier can be used.

U.S. Pat. No. 6,488,205 B1 to Jacobson describes a system and method for extracting and processing data contained on an information card, particularly a healthcare plan identification card. The data preferably includes both textual data and graphical data, but can contain either type of data singularly. The system preferably associates the textual and graphical data or a portion thereof with a healthcare plan sponsor. In addition, the system analyzes the data to determine a healthcare plan product identifier. Based upon the healthcare plan product identifier, the system provides information about the healthcare plan product so that decisions can be made about an individual associated with the healthcare plan product.

U.S. Pat. No. 6,449,621 B1 to Pettovello describes a privacy data escrow system that includes at least one data provider having a plurality of privacy data records of a plurality of persons. Each privacy data record is associated with a unique person identifier of a person, and each of the at least one data provider having a unique data provider identifier associated therewith. An escrow agent is in communication with the at least one data provider and is operable to receive and store, from the at least one data provider, a plurality of person identifiers, and a plurality of unique scrambled person identifiers and data provider identifiers associated with each person identifier. A database is in communication with the at least one data provider and is operable to receive and store, from the at least one data provider, the plurality of privacy data records, the plurality of scrambled person identifiers associated with the privacy data records, and the data provider identifiers. The database is further operable to receive and store, from the escrow agent, a unique universal anonymous identifier to replace each scrambled person identifier whereby each privacy data record stored in database is identifiable by a universal anonymous identifier.

U.S. Pat. No. 6,347,329 B1 to Evans describes a medical records system that creates and maintains all patient data electronically. The system captures patient data, such as patient complaints, lab orders, medications, diagnoses, and procedures, at its source at the time of entry using a graphical user interface having touch screens. Using pen-based portable computers with wireless connections to a computer network, authorized healthcare providers can access, analyze, update and electronically annotate patient data even while other providers are using the same patient record. The system likewise permits instant, sophisticated analysis of patient data to identify relationships among the data considered. Moreover, the system includes the capability to access reference databases for consultation regarding allergies, medication interactions and practice guidelines. The system also includes the capability to incorporate legacy data, such as paper files and mainframe data, for a patient.

U.S. Pat. No. 6,304,849 B1 to Uecker et al. describes a system and method for printing a customized combination newsletter and product label for use in dispensing prescribed pharmaceutical products. An individual's medical status is determined based upon information provided to the dispensing pharmacist and a customized newsletter, which may contain standard information not customized for the individual, is printed onto a combination form that also contains a self-adhesive label which can be placed upon the dispensed pharmaceutical product container. The combination form containing both the newsletter and container label facilitate giving the newsletter to the proper individual.

U.S. Pat. No. 6,112,182 to Akers et al. describes a computer-based pharmaceutical practice management system and a healthcare management system for use by a pharmacy. It includes a processes by which health conditions of a patient, drugs taken the patient and other information gathered by the pharmacist with the practice-management system in connection with dispensing the will automatically initiate related actions handled by processes of the healthcare management system.

U.S. Pat. No. 5,924,074 to Evans describes a medical records system that creates and maintains all patient data electronically. The system captures patient data, such as patient complaints, lab orders, medications, diagnoses, and procedures, at its source at the time of entry using a graphical user interface having touch screens. Using pen-based portable computers with wireless connections to a computer network, authorized healthcare providers can access, analyze, update and electronically annotate patient data even while other providers are using the same patient record. The system likewise permits instant, sophisticated analysis of patient data to identify relationships among the data considered. Moreover, the system includes the capability to access reference databases for consultation regarding allergies, medication interactions and practice guidelines. The system also includes the capability to incorporate legacy data, such as paper files and mainframe data, for a patient.

U.S. Pat. No. 5,905,652 to Kutsuma describes a system for guiding the taking of medicine having a host computer, a personal computer connected to the host computer, and a color printer connected to the personal computer to produce a document or a medicine bag with guiding instructions for taking medicine prepared by the system printed thereon. A doctor uses the host computer for inputting prescription information for a patient. The input information is transmitted to the personal computer from the host computer. The pharmacist edits the information received from the host computer to prepare the medicine bag and/or document by printing the edited guiding instructions for taking medicine inclusive of visual image of each drug thereon.

U.S. Pat. No. 5,877,742 to Klink describes a traditional, yet more stylish, medical identification bracelet which has electronic circuitry to display detailed, patient medical information. The bracelet is formatted using a programming station (PC) into which is entered up to 16 k bits of medical & personal information about an individual. The programming station transfers the formatted information to the bracelet via an infra-red interface device. The medical identification bracelet has an LCD view screen which displays, in a scrolling fashion, data when a button is pushed. The information may be scrolled in either direction, paused and set to free run. All information is available at the display. The character size is selected to be visible to the unaided eye. The display is illuminated for low light reading.

U.S. Pat. No. 5,542,420 to Goldman et al. describes a health care system for specifying edibles to individual subjects. The personalized method and system for storage, communication, analysis and processing of health-related data comprises a storage containing data relating to health and edibles and is adapted to receive data on the conditions and characteristics of the individual subjects. The health care system further comprises input terminals adapted to be coupled to the storage means for providing data on the conditions and characteristics of the individual subjects, and a health computer for correlating the data relating to health and edibles with the data on the condition and characteristics of an individual subject to provide a personalized prescription of edibles.

Notwithstanding the prior art, the present invention is neither taught nor rendered obvious thereby.

### SUMMARY OF INVENTION

The present invention is directed to a pharmacy-based data transfer methodology. It includes providing at least one computer with sufficient software and hardware to perform the following, and performing the following: (i) receive and store a set of unique identifiers, each of the set of unique identifiers corresponding to a specific different patient; (ii) receive prescription medication information data on patient having stored unique identifier, attaching received prescription medication information data to the corresponding patient's unique identifier and storing it, wherein the prescription medication information data at least includes patient identification, date of the prescription, medication of the prescription, dosage of the medication and a consumption indicator; and (iii) generate a printed pharmacy data card for a patient showing the unique identifier and corresponding prescription medication information data for each of the prescriptions that have been stored for the patient; and, providing the printed pharmacy data card to its corresponding patient.

In some preferred embodiments of the present invention pharmacy-based data transfer methodology, the consumption indicator is selected from the group consisting of prescription quantity, prescription use directions, prescription refill information and combination thereof.

In some preferred embodiments of the present invention pharmacy-based data transfer methodology, the software further includes prescription filling capability and wherein there is automatic generation of a printed pharmacy data card each time a patient has a prescription of medication filled.

In some preferred embodiments of the present invention pharmacy-based data transfer methodology, the software includes automatic establishment of a unique identifier for a patient the first time the patient fills a prescription that is inputted into the software.

In some preferred embodiments of the present invention pharmacy-based data transfer methodology, the at least one computer includes software to generate a prescription label for a package of medication based on information input from a pharmacy personnel.

In some preferred embodiments of the present invention pharmacy-based data transfer methodology, software further includes automatic generation of a printed pharmacy data card each time a patient has a prescription of medication filled.

In some preferred embodiments of the present invention pharmacy-based data transfer methodology, software further includes storing of additional prescription data and attaching it to its corresponding prescription information data, the additional prescription data being selected from the group consisting of interactions, cautions, restrictions, warning and combination thereof and printing the medication information data on the printed pharmacy data card.

In some preferred embodiments of the present invention pharmacy-based data transfer methodology, software further includes receiving and storing patient allergies, special needs and adverse reaction history and attaching these to the unique identifier for subsequent inclusion on the printed pharmacy data card.

In some preferred embodiments of the present invention pharmacy-based data transfer methodology, the prescription medication information data is stored in chronological orders.

In some preferred embodiments of the present invention pharmacy-based data transfer methodology, the software and hardware further includes receiving, storing and generating patient care date and attaching it to a patient unique identifier.

In some preferred embodiments of the present invention pharmacy-based data transfer methodology, includes providing at least one host server computer and a plurality of internet connected user computers to establish a pharmacy-based data transfer system, the system having sufficient software and hardware to perform the following, and performing the following: (i) receive and store a set of unique identifiers, each of the set of unique identifiers corresponding to a specific different patient; (ii) receive prescription medication information data on patient having stored unique identifier, attaching received prescription medication information data to the corresponding patient's unique identifier and storing it, wherein the prescription medication information data at least includes patient identification, date of the prescription, medication of the prescription, dosage of the medication and a consumption indicator; (iii) generate a printed pharmacy data card for a patient showing the unique identifier and corresponding prescription medication information data for each of the prescriptions that have been stored for the patient; providing the printed pharmacy data card to its corresponding patient.

In some preferred embodiments of the present invention pharmacy-based data transfer methodology, the consumption indicator is selected from the group consisting of prescription quantity, prescription use directions, prescription refill information and combination thereof.

In some preferred embodiments of the present invention pharmacy-based data transfer methodology, the software further includes prescription filling capability and wherein there is automatic generation of a printed pharmacy data card each time a patient has a prescription of medication filled.

In some preferred embodiments of the present invention pharmacy-based data transfer methodology, the software includes automatic establishment of a unique identifier for a patient the first time the patient fills a prescription that is inputted into the software.

In some preferred embodiments of the present invention pharmacy-based data transfer methodology, the at least one computer includes software to generate a prescription label for a package of medication based on information input from a pharmacy personnel.

In some preferred embodiments of the present invention pharmacy-based data transfer methodology, software further includes automatic generation of a printed pharmacy data card each time a patient has a prescription of medication filled.

In some preferred embodiments of the present invention pharmacy-based data transfer methodology, software further includes storing of additional prescription data and attaching it to its corresponding prescription information data, the additional prescription data being selected from the group consisting of interactions, cautions, restrictions, warning and combination thereof and printing the medication information data on the printed pharmacy data card.

In some preferred embodiments of the present invention pharmacy-based data transfer methodology, software further includes receiving and storing patient allergies, special needs and adverse reaction history and attaching these to the unique identifier for subsequent inclusion on the printed pharmacy data card.

In some preferred embodiments of the present invention pharmacy-based data transfer methodology, the prescription medication information data is stored in chronological orders.

In some preferred embodiments of the present invention pharmacy-based data transfer methodology, the software and hardware further includes receiving, storing and generating patient care date and attaching it to a patient unique identifier.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 illustrates a block diagram of one embodiment of the present invention pharmacy-based data transfer methodology;

FIG. 2 illustrates a block diagram showing details and options for some of the components shown in FIG. 1;

FIG. 3 illustrates a block diagram of another embodiment of the present invention pharmacy-based data transfer methodology;

FIG. 4 illustrates the same methodology as set forth in FIG. 3, except that the software now includes automatic set up of a patient data block at the time the first prescription for that patient is filled;

FIG. 5 illustrates in block diagram form a basic arrangement for plural computers as a platform for the present invention methodology;

FIG. 6 illustrates details of one possible computer arrangement for the present invention methodology involving multiple computers at different pharmacy locations;

FIG. 7 illustrates details of one possible computer arrangement for another present invention methodology involving multiple computers at different pharmacy locations;

FIG. 8 is similar to the present invention arrangement shown in FIG. 7, but includes alternative provisions, such as email, for providing patients with a pharmacy data card; and,

FIG. 9 illustrates in block diagram form a basic arrangement for a pharma-based patient data card resulting from the present invention methodology.

### DETAILED DESCRIPTION OF THE EMBODIMENTS

Referring now in detail to the drawings wherein like reference numerals designate corresponding parts throughout the several views, various embodiments of the present invention are shown.

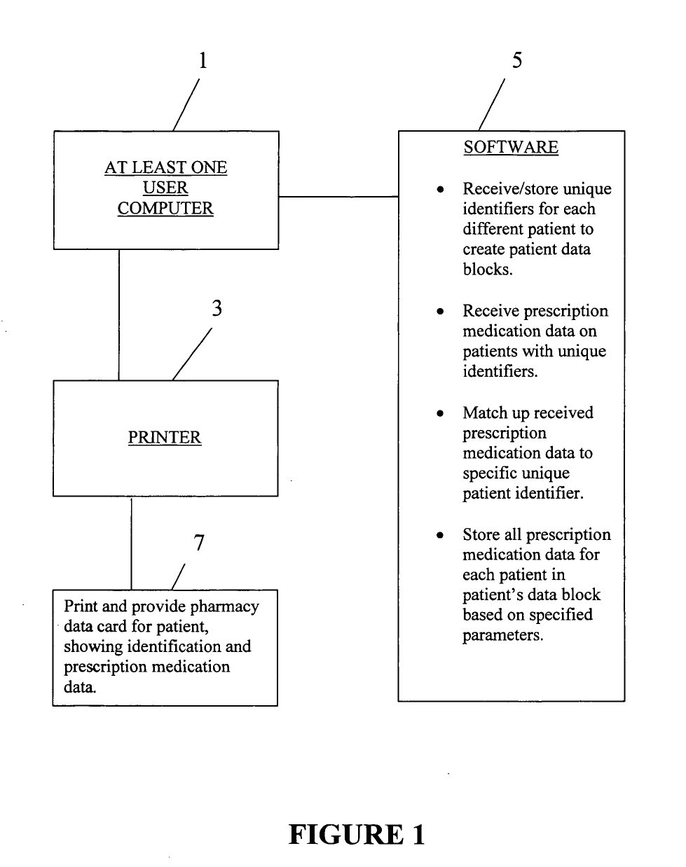

FIG. 1 illustrates a block diagram of one embodiment of the present invention pharmacy-based data transfer methodology. Block 1 indicates a methodology system having at least one computer. In its simplest format, a single computer will be sufficient, but as a practical matter, most pharmacies have more than one computer. There is a printer 3 connected to the at least one computer and the computer includes physical capabilities and software to perform the methodology. Block 5 illustrates the essential software for this embodiment: software that will (a) Receive/store unique identifiers for each different patient to create patient data blocks; (b) Receive prescription medication data on patients with unique identifiers; (c) Match up received prescription medical data to specific unique patient identifier, and (d) Store all prescription medication data for each patient in patient's data block based on specified parameters. Thus, the methodology is the software functions of Block 5 when utilized in conjunction with the hardware of FIG. 1. Printer 3 generates the pharmacy data card for the patients (Block 7).

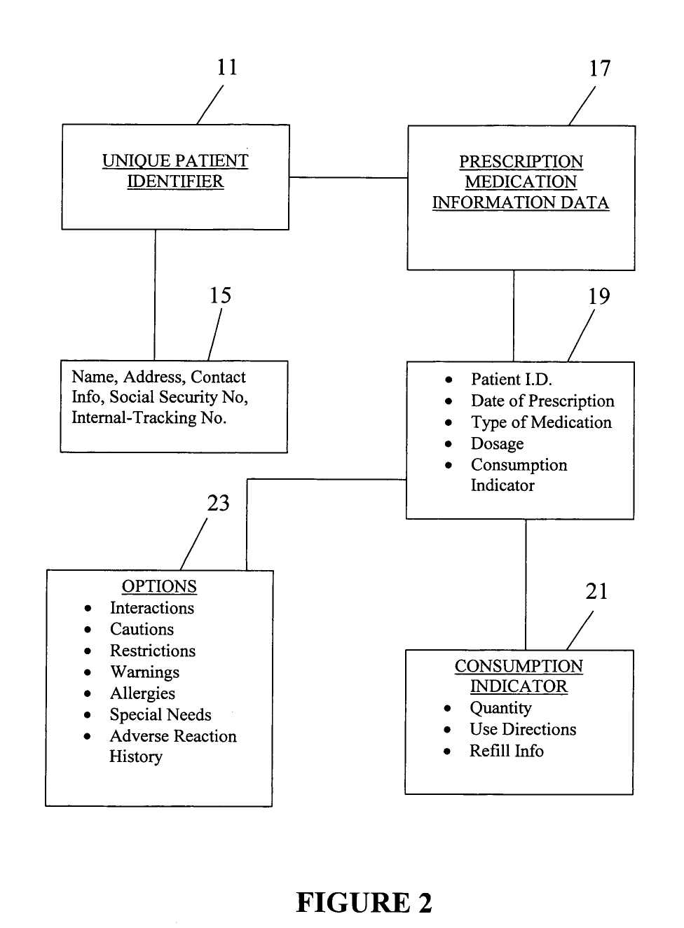

FIG. 2 illustrates a block diagram showing details and options for some of the software components and inputs shown in the FIG. 1 system. The Unique Patient Identifier (Block 11) may include the elements of block 15: Name, Address, Contact Info, Social Security No, Internal-Tracking No. The Unique Patent Identifier (Block 11) is linked to the Prescription Medication Information Data (Block 17) via the software set forth in FIG. 1. The Prescription Medication Information Data of Block 17 may include the information set forth in Block 19: Patient I.D., Date of Prescription, Type of Medication, Dosage and Consumption Indicator. Block 21 shows some possible consumption indicators: Quantity, Use Directions and Refill Information. Optional information data is shown in Block 13. These include drug Interactions, Cautions, Restrictions, Warnings, Allergies, Special Needs and Adverse Reaction History.

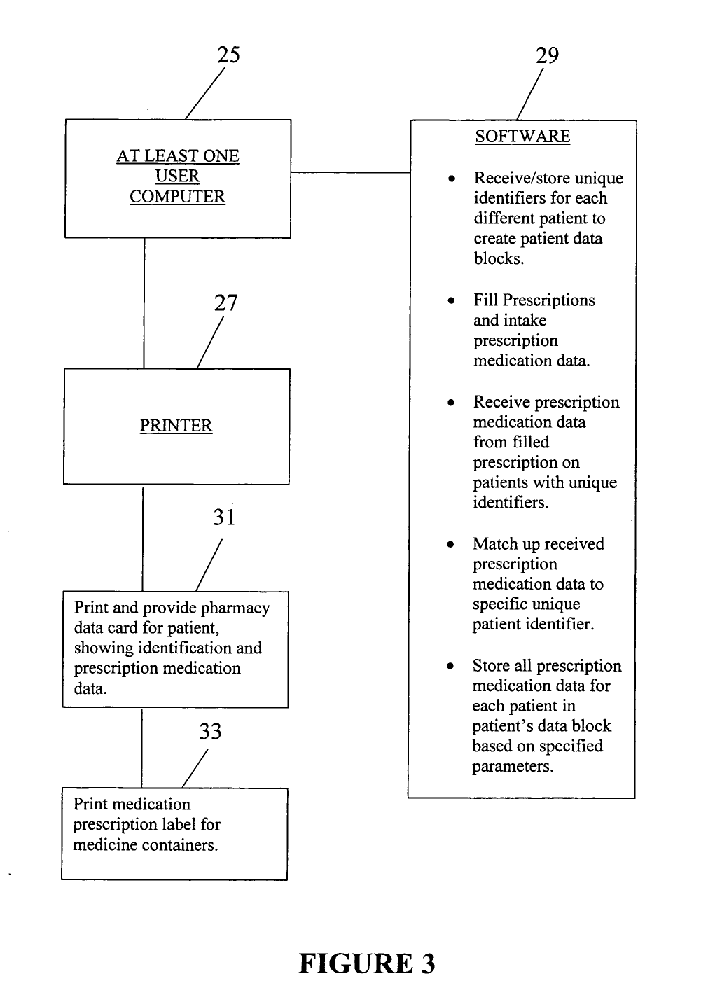

FIG. 3 illustrates a block diagram of another embodiment of the present invention pharmacy-based data transfer methodology. As in FIG. 1, there is at least one computer (Block 25), a printer (Block 27) and the software (Block 29). The software in this Figure is the same as the software in FIG. 1 except that this software now includes the ability to fill prescriptions and intake prescription medicine data for further processing (Block 29) as well as printing both patient data cards (Block 31) and printing prescription labels for medicine containers (Block 33).

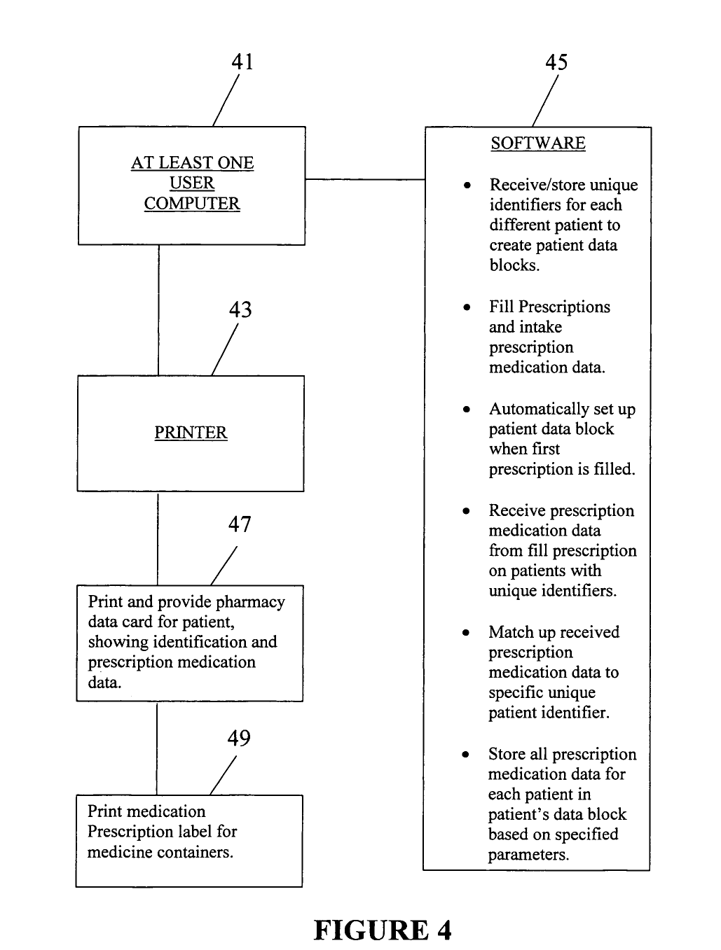

FIG. 4 illustrates the same methodology as set forth in FIG. 3, except that the software now includes automatic set up of a patient data block at the time the first prescription for that patient is filled. Thus, Blocks 41, 43, 47 and 49 are the same as Blocks 25, 27, 31 and 33 of FIG. 3. Further the software Block 45 differs only from FIG. 3 software Block 29 in that it now includes automatic patient data block set up when a first prescription is filled.

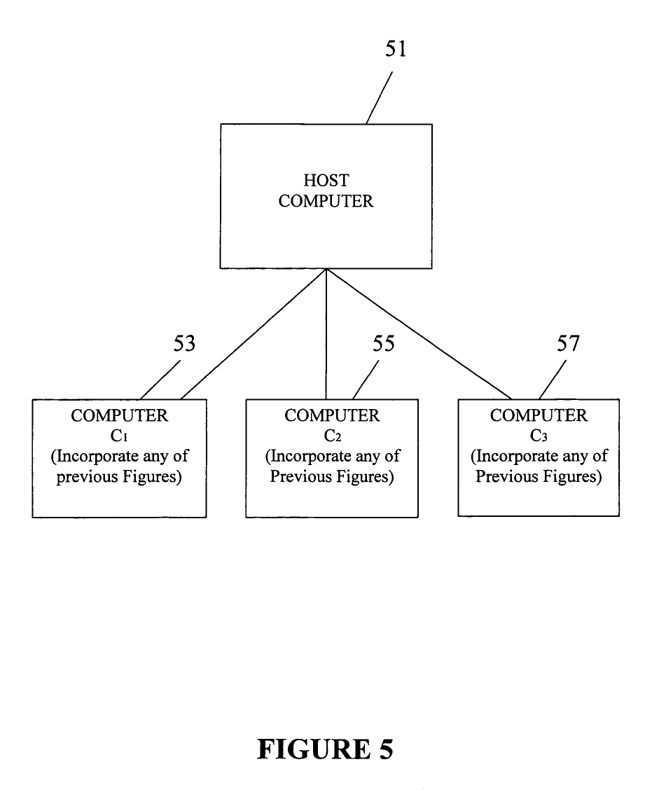

FIG. 5 illustrates in block diagram form a basic arrangement for plural computers as a platform for the present invention methodology. In FIG. 5, Host Computer 51 may have host software to perform interfacing, communications and the same software functions and methodologies set forth in the previous figures, on a plurality of computers such as Computer C₁ (Block 53), Computer C₂ (Block 55) and Computer C₃ (Block 57). Each of these separate computers are connected via intranet or internet to Host Computer 51 and may include whatever software or subsoftware is necessary to perform as described herein. Further, Host Computer 51 will also serve as a data consolidater and a data communicator, so that all computers have all information on all patients, regardless of where the patient data block is initiated or where any prescription may have been filled. This FIG. 5 configuration is particularly useful for the present invention methodology wherein a single pharmacy has plural points of sale (computers) or for a small group of pharmacies.

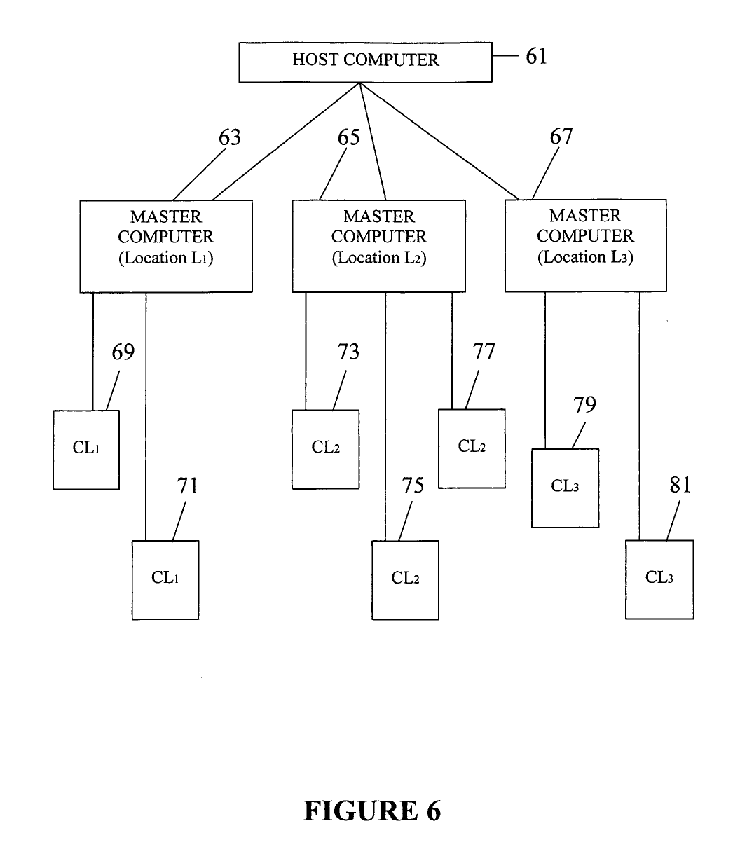

FIG. 6 illustrates details of one possible computer arrangement for the present invention methodology involving multiple computers at different pharmacy locations. In FIG. 6, Host Computer 61 may have host software to perform interfacing, communications and the same software functions and methodologies set forth in the previous figures, on a plurality of computers such as Master Computer (Block 63), Master Computer (Block 65) and Master Computer (Block 67). Each of these Master Computers are remote from one another at different locations L1, L2 and L3, respectively. For example they would typically be at different pharmacy stores. Further, each pharmacy store would have a plurality of separate points of sale, such as Computers CL1 (Blocks 69 and 71) at location L1; Computers CL2 (Blocks 73, 75 and 77) at location L2; Computers CL3 (Blocks 79 and 81) at location L3. Each Master Computer will enable a pharmacy store to look at activity within its own location, as well as global activities for the entire pharmacy chain.

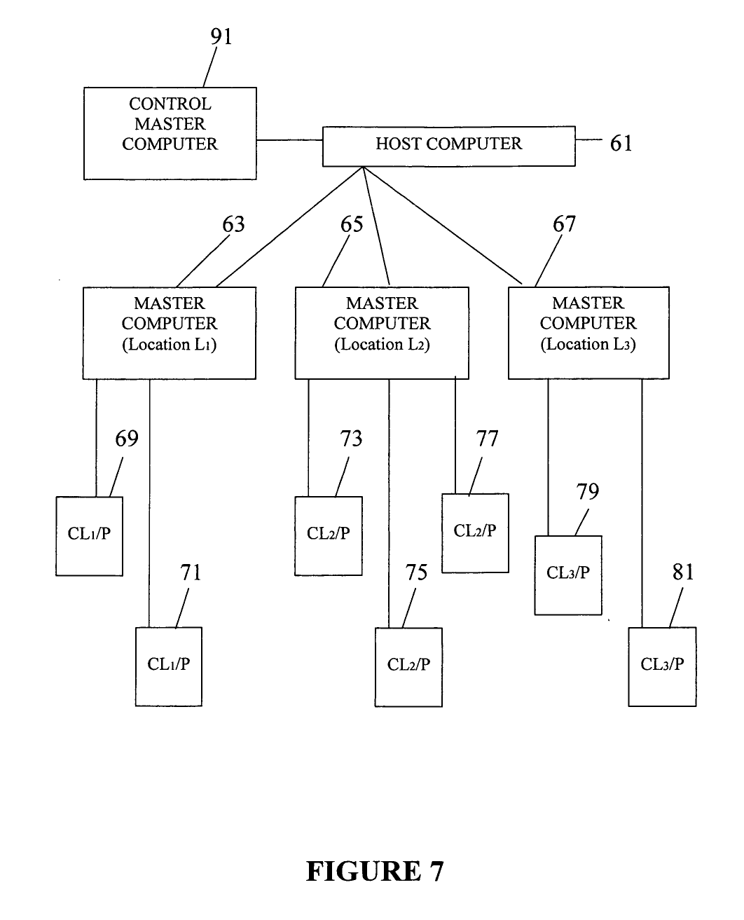

FIG. 7 illustrates details of one possible computer arrangement for another present invention methodology involving multiple computers at different pharmacy locations. FIG. 7 has the same components and Block numbers as set forth in FIG. 6, except that Control Master Computer (Block 91) enables corporate headquarters of a pharmacy chain to include other features, such as maintaining patient records on a lifetime, rather than one year back, history, and/or utilizing the patient data blocks for an annual patient data mail out with a newsletter or other promotional feature.

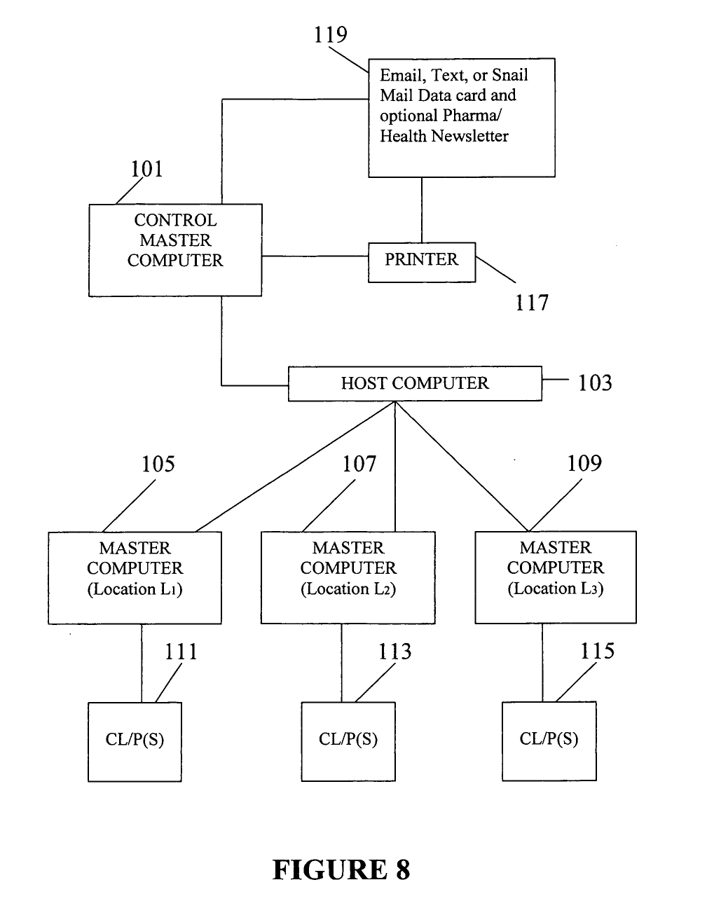

FIG. 8 is similar to the present invention arrangement shown in FIG. 7, but includes alternative provisions, such as email, for providing patients with a pharmacy data card. Blocks 101, 103, 105, 107 and 109 correspond to Blocks 91, 61, 63, 65 and 67 of FIG. 7. Printer 117 has been added to generate items in Block 119: Email, Text, or Snail Mail Data card and optional Pharma/Health Newsletter.

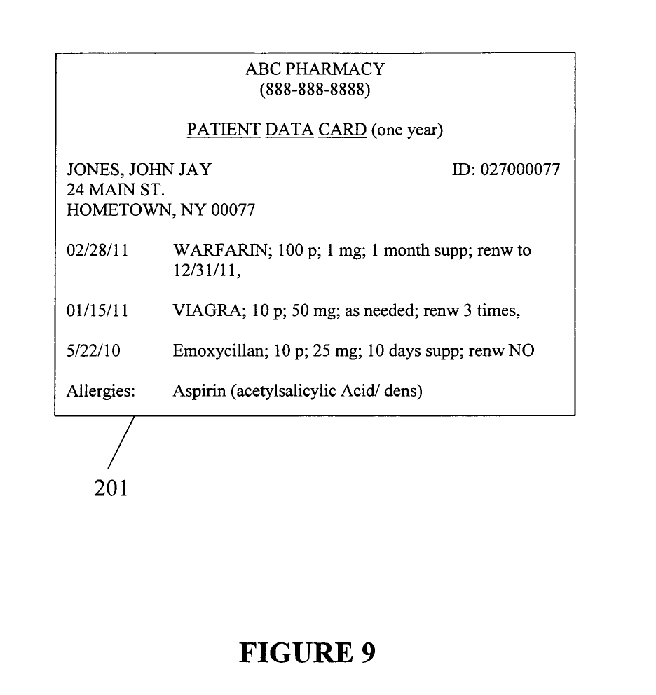

FIG. 9 illustrates in block diagram form a basic arrangement for a pharma-based patient data card resulting from the present invention methodology (Block 201). In this Figure, Block 201, represents a patient data card that includes the name and contact number of the pharmacy or pharmacy company issuing the card, the patient name, address, a unique identifier (social security number), prescriptions filled over the past year and allergies.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims. For example, the card shown in FIG. 9 could include information for more than a year, references to internet links for long form warning inserts for each prescription, contraindications, etc.

What is claimed is:

1. A pharmacy-based data transfer methodology, which comprises:
a) providing at least one computer with sufficient software and hardware to perform the following, and performing the following:
(i) receive and store a set of unique identifiers, each of said set of unique identifiers corresponding to a specific different patient;
(ii) receive prescription medication information data on patient having stored unique identifier, attaching received prescription medication information data to the corresponding patient's unique identifier and storing it, wherein said prescription medication information data at least includes patient identification, date of the prescription, medication of the prescription, dosage of the medication and a consumption indicator;
(iii) generate a printed pharmacy data card for a patient showing said unique identifier and corresponding prescription medication information data for each of the prescriptions that have been stored for said patient;
b) providing said printed pharmacy data card to its corresponding patient.

2. The pharmacy-based data transfer methodology of claim 1 wherein said consumption indicator is selected from the group consisting of prescription quantity, prescription use directions, prescription refill information and combination thereof.

3. The pharmacy-based data transfer methodology of claim 1 wherein said software further includes prescription filling capability and wherein there is automatic generation of a printed pharmacy data card each time a patient has a prescription of medication filled.

4. The pharmacy-based data transfer methodology of claim 3 wherein said software includes automatic establishment of a unique identifier for a patient the first time said patient fills a prescription that is inputted into said software.

5. The pharmacy-based data transfer methodology of claim 1 wherein said at least one computer includes software to generate a prescription label for a package of medication based on information input from a pharmacy personnel.

6. The pharmacy-based data transfer methodology of claim 5 wherein software further includes automatic generation of a printed pharmacy data card each time a patient has a prescription of medication filled.

7. The pharmacy-based data transfer methodology of claim 1 wherein software further includes storing of additional prescription data and attaching it to its corresponding prescription information data, said additional prescription data being selected from the group consisting of interactions, cautions, restrictions, warning and combination thereof and printing said medication information data on said printed pharmacy data card.

8. The pharmacy-based data transfer methodology of claim 1 wherein software further includes receiving and storing patient allergies, special needs and adverse reaction history and attaching these to said unique identifier for subsequent inclusion on said printed pharmacy data card.

9. The pharmacy-based data transfer methodology of claim 1 wherein said prescription medication information data is stored in chronological orders.

10. The pharmacy-based data transfer methodology of claim 1 wherein said software and hardware further includes receiving, storing and generating patient care date and attaching it to a patient unique identifier.

11. A pharmacy-based data transfer methodology, which comprises:
a) providing at least one host server computer and a plurality of internet connected user computers to establish a pharmacy-based data transfer system, said system having sufficient software and hardware to perform the following, and performing the following:
(i) receive and store a set of unique identifiers, each of said set of unique identifiers corresponding to a specific different patient;
(ii) receive prescription medication information data on patient having stored unique identifier, attaching received prescription medication information data to the corresponding patient's unique identifier and storing it, wherein said prescription medication information data at least includes patient identification, date of the prescription, medication of the prescription, dosage of the medication and a consumption indicator;
(iii) generate a printed pharmacy data card for a patient showing said unique identifier and corresponding prescription medication information data for each of the prescriptions that have been stored for said patient;
b) providing said printed pharmacy data card to its corresponding patient.

12. The pharmacy-based data transfer methodology of claim 11 wherein said consumption indicator is selected from the group consisting of prescription quantity, prescription use directions, prescription refill information and combination thereof.

13. The pharmacy-based data transfer methodology of claim 11 wherein said software further includes prescription filling capability and wherein there is automatic generation of a printed pharmacy data card each time a patient has a prescription of medication filled.

14. The pharmacy-based data transfer methodology of claim 13 wherein said software includes automatic establishment of a unique identifier for a patient the first time said patient fills a prescription that is inputted into said software.

15. The pharmacy-based data transfer methodology of claim 11 wherein said at least one computer includes software to generate a prescription label for a package of medication based on information input from a pharmacy personnel.

16. The pharmacy-based data transfer methodology of claim 15 wherein software further includes automatic generation of a printed pharmacy data card each time a patient has a prescription of medication filled.

17. The pharmacy-based data transfer methodology of claim 11 wherein software further includes storing of additional prescription data and attaching it to its corresponding prescription information data, said additional prescription data being selected from the group consisting of interactions, cautions, restrictions, warning and combination thereof and printing said medication information data on said printed pharmacy data card.

18. The pharmacy-based data transfer methodology of claim 11 wherein software further includes receiving and storing patient allergies, special needs and adverse reaction history and attaching these to said unique identifier for subsequent inclusion on said printed pharmacy data card.

19. The pharmacy-based data transfer methodology of claim 11 wherein said prescription medication information data is stored in chronological orders.

20. The pharmacy-based data transfer methodology of claim 11 wherein said software and hardware further includes receiving, storing and generating patient care date and attaching it to a patient unique identifier.
